(19) United States
(12) Patent Application Publication
(10) Pub. No.: US 2011/0016975 A1
(43) Pub. Date: Jan. 27, 2011

(54) Method and Apparatus For Measuring In-Situ Characteristics Of Material Exfoliation

(76) Inventors: Gregory Scott Glaesemann, Corning, NY (US); Jessica Danielle Maurer, Painted Post, NY (US); Johannes Moll, Corning, NY (US); Jayantha Senawiratne, Painted Post, NY (US)

Correspondence Address: CORNING INCORPORATED, SP-TI-3-1, CORNING, NY, 14831, US

(21) Appl. No.: 12/509,139

(22) Filed: Jul. 24, 2009

(51) Int. Cl. G01N 29/04

(52) U.S. Cl. 73/588

(57) ABSTRACT

Methods and apparatus for measuring, in-situ, at least one characteristic of a bonding process between a material sheet and a substrate, include: producing acoustic signals in response to acoustic energy within at least one of the material sheet and the substrate proximate to a bonding interface between the material sheet and the substrate; and deriving the at least one characteristic of the bonding process from the acoustic signals.

### BACKGROUND

The embodiments herein relate to the measurement of one or more characteristics associated with bonding one material to another material, such as measuring certain characteristics associated with the exfoliation of a layer of semiconductor material from a donor wafer in a semiconductor-on-insulator (SOI) bonding process.

Among the ways to produce SOI structures include ion-implantation methods, such as those disclosed in U.S. Pat. No. 7,176,528. Such steps include: (i) exposing a silicon wafer surface to hydrogen ion implantation to create a bonding surface; (ii) bringing the bonding surface of the wafer into contact with a glass substrate; (iii) applying pressure, temperature and voltage to the wafer and the glass substrate to facilitate bonding therebetween; (iv) cooling the structure to a common temperature; and (v) separating the glass substrate and a thin layer of silicon from the silicon wafer.

The in-situ measurement of certain characteristics associated with the exfoliation of a layer of semiconductor material from a donor wafer, e.g., the extent and location of specific sites at which a material begins to exfoliate, may be advantageous in the manufacture of various products, such as to test process variation, improve yield, monitor product quality, etc. The in-situ measurement of such characteristics may also be advantageous in the design of new products and systems, such as in the development of SOI structures.

By way of example, the application of SOI related structures in electronic devices is strongly hindered by the formation of defects in the SOI structure, particularly voids and cracks in the crystalline structure of the thin, semiconductor layer bonded to the insulating substrate. The identification of the root causes of such defects may be the key to the development of defect-free crystalline SOI structures, and thus improved electronic properties of the material. In order to achieve this objective, an understanding of the fundamental dynamics of the bonding process is required. Thus, a real-time monitoring technique would be useful for monitoring the bonding process of SOI fabrication, especially for industrial-level mass production.

There are a number of existing techniques for in-situ monitoring of the SOI wafer bonding process. For example, in situ monitoring of wafer bonding time has included the detection of the deflection of semiconductor wafer edges during the bonding process, such as is disclosed in W02008144264 and US2008/0285059A1. The major disadvantages of such a method include high sensitivity to external mechanical vibrations, inability to detect the formation of defects (such as voids, cracks etc.), and low reliability (because the signal does not directly originate from the implantation layer). In-situ bonding process monitoring has also been carried out by means of optical reflection spectroscopy, as is described in US2004/0228437A1. The major disadvantages of this method include the need for a complicated experimental setup, that the measurement is affected by the ambient light because detection is based on light reflection, that the measurement cannot detect the formation of defects (such as voids, cracks etc.), and that the measurement is not very sensitive to reaction kinetics at the implantation layer since the material is opaque.

For the reasons discussed above, none of the aforementioned techniques and processes for in-situ measurement of the bonding process has been satisfactory, such as in the context of manufacturing SOI structures. Thus, there is a need in the art for new methods and apparatus for real-time, in-situ process monitoring of the SOI bonding process.

### SUMMARY

Methods and apparatus for the in-situ monitoring of a material bonding process provide for detection of an acoustic emission signal originating from a rapid redistribution of stresses in a donor wafer. The method includes measurement of an acoustic emission (AE) signal, which is in the ultrasonic region (above 20 kHz), emitted during the bonding process by using an appropriate transducer, such as one or more piezoelectric transducers. Through analysis of the measured AE signal, such as amplitude, frequency, counts, rise time, energy, etc., the dynamics of the bonding process, including formation of defects, micro cracking, and exfoliation, can be non-destructively monitored.

Measuring the AE signal using three or more (appropriately located) sensors permits triangulating the detected AE signal, and thus determining the source location in two dimensions may be achieved. Improvement in the source location accuracy may be achieved by minimizing acoustic reflections from substrate edges (to which, for example, a semiconductor material is bonded) by applying a coating to modify the surrounding vertical edges of the substrate.

In addition, simultaneous parametric measurements, such as temperature, applied pressure, and applied voltage, etc., along with AE detection allows one to correlate AE events with such parametric measurements to develop a better understanding of the bonding process and how it may be controlled and/or improved.

The various aspects of the in-situ monitoring may be used in controlling, modifying, testing, for example, the exfoliation portion of the bonding process. By way of example, aspects of the in-situ monitoring approach may be used to “proof test” parts. In particular, one may measure the AE signal and identify defects that might pose a processing or functional issue. Any defective structures may be culled out of the manufacturing process. If the defective structures include, for example, a large non-exfoliated region or similar defect, such that the part is no longer useful, one may eliminate this defective part before any further inspection or processing, thereby lowering manufacturing costs. In some applications, the in-situ monitoring approach may be used to identify strength controlling defects in bonded structures, and therefore, one may implement a classing mechanical proof test. Aspects of the in-situ monitoring technique described herein, however, may further provide a means for a non-stress proof test. Thus, the test may be integral to the overall manufacturing process. Another application of the in-situ monitoring technique is to identify glass fracture during heating to exfoliation, and in response, to shut down the bonder apparatus, thereby avoiding the completion of the entire heating cycle following glass fracture (which lowers manufacturing costs).

Methods and apparatus for the measurement of at least one characteristic of a bonding process between a material sheet and a substrate provide for: producing acoustic signals in response to acoustic energy within at least one of the material sheet and the substrate proximate to a bonding interface between the material sheet and the substrate; and deriving the at least one characteristic of the bonding process from the acoustic signals. The acoustic energy may be produced by at least one of: an exfoliation of a layer from the material sheet that is being bonded to the substrate; and formation of one or more defects in the material sheet or in the bonding interface between the material sheet and the substrate during the bonding process.

The methods and apparatus may further provide for at least one of: sensing at least one of temperature, pressure, and voltage associated with parameters of the bonding process; associating the acoustic signals with at least one of the temperature, the pressure, and the voltage; associating a formation of one or more defects in the material sheet or in the bonding interface between the material sheet and the substrate during the bonding process with at least one of the temperature, the pressure, and the voltage; and identifying respective states of one or more of the temperature, the pressure, and the voltage at initiation of the formation of the one or more defects.

The methods and apparatus may further provide for: producing at least three sources of acoustic signals for a given source of acoustic energy; and computing one or more locations from which the acoustic energy originates proximate to the bonding interface from the at least three sources of acoustic signals.

Other aspects, features, advantages, etc. will become apparent to one skilled in the art when the description herein is taken in conjunction with the accompanying drawings.

### BRIEF DESCRIPTION OF THE DRAWINGS

For the purposes of illustrating the various features disclosed herein, there are shown in the drawings forms that are presently preferred, it being understood, however, that the invention is not limited to the precise arrangements and instrumentalities shown.

FIG. 1 is a partial block diagram and partial circuit diagram illustrating an apparatus for monitoring a process of bonding a material (such as semiconductor material) to a substrate (such as a glass or glass ceramic substrate) in accordance with one or more embodiments disclosed herein;

FIG. 2 is a side view of the apparatus of FIG. 1 in accordance with one or more further embodiments disclosed herein;

FIG. 3 is a top view of the apparatus of FIG. 1 in accordance with one or more further embodiments disclosed herein;

FIG. 4 is a further side view of the apparatus of FIG. 1 in accordance with one or more further embodiments disclosed herein;

FIG. 5 is a graphical illustration of a measured acoustic emission signal, and derived waveforms thereof, obtained from a sample using the apparatus of FIG. 1;

FIG. 6 is a graphical illustration of a measured acoustic emission signal having two modes obtained from a sample using the apparatus of FIG. 1;

FIG. 7 is a graphical illustration of two measured acoustic emission signals, the upper signal having been obtained from a sample in which acoustic reflections were significantly present within the substrate, and the lower signal having been obtained from a sample in which acoustic reflections had been reduced within the substrate;

FIG. 8 is a graphical illustration of three measured acoustic emission signals, one signal having been obtained from a reference, substrate-only sample, a next signal having been obtained from a sample having a round semiconductor material bonded to the substrate, and a final signal having been obtained from a sample having a rectangular (tiled) semiconductor material bonded to the substrate; and

FIGS. 9A and 9B are graphical illustrations of the respective amplitudes of two measured acoustic emission signals measured by four acoustic sensors, the FIG. 9A signal having been obtained from a sample having a rectangular (tiled) semiconductor material bonded to the substrate, and the FIG. 9B signal having been obtained from a sample having a round semiconductor material bonded to the substrate.

### DETAILED DESCRIPTION

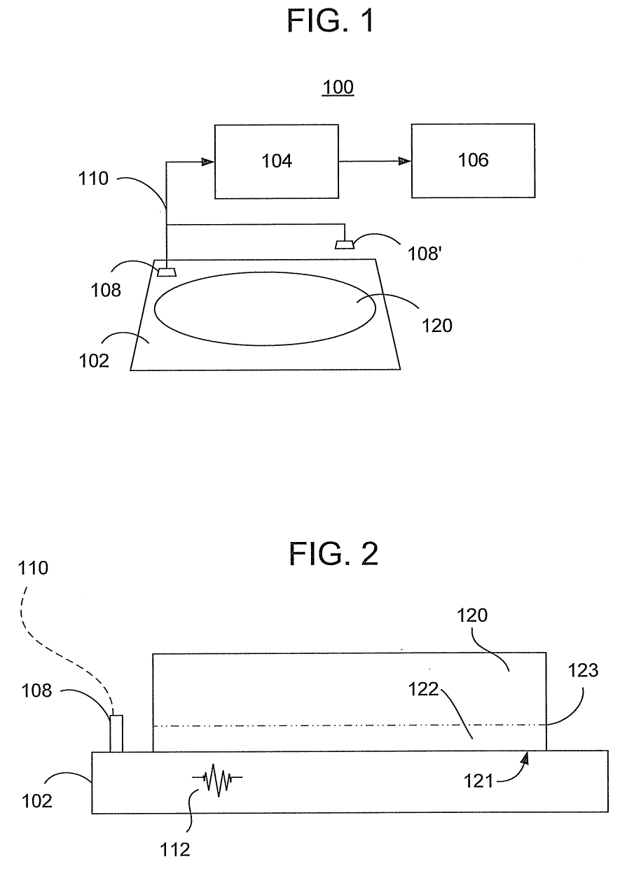

With reference to the drawings, wherein like numerals indicate like elements, there are shown in FIGS. 1-4 various embodiments of an in-situ monitoring apparatus 100 for measuring one or more characteristics of a bonding operation. The apparatus 100 may operate, for example, to measure one or more characteristics of a bonding process (such as an anodic bonding process) of a sample piece of material 120, which may be a semiconductor wafer, such as a silicon wafer, to a substrate 102, such as a glass or glass-ceramic material, or any other suitable substrate material.

The apparatus 100 includes at least one acoustic sensor 108, signal conditioning circuitry 104, and a computing system 106. The acoustic sensor 108 is coupled to the substrate 102 (or in an alternative embodiment to the material 120 itself), where the acoustic sensor 108 operates to produce a signal in response to acoustic energy 112 produced proximate to a bonding interface between the material 120 and the substrate 102. The conditioning circuitry 104 and the computing system 106 operate in conjunction to analyze the acoustic signals and derive the at least one characteristic of the anodic bonding process therefrom.

Before discussing further details of the apparatus 100, a discussion will first be provided as to an exemplary context within which the sample 120 may be found and certain processing that may be carried out thereon. For purposes of discussion, the methods and apparatus described herein may be in the context of the development and/or manufacture of SOI structures. The SOI structures have suitable uses in connection with fabricating thin film transistors (TFTs), e.g., for display applications, including organic light-emitting diode (OLED) displays and liquid crystal displays (LCDs), integrated circuits, photovoltaic devices, etc.

To date, the semiconductor material most commonly used in SOI structures has been silicon. Such structures have been referred to in the literature as silicon-on-insulator structures and the abbreviation “SOI” has been applied to such structures. SOI technology is becoming increasingly important for high performance thin film transistors, solar cells, and displays, such as, active matrix displays. SOI structures may include a thin layer of substantially single crystal silicon on an insulating material.

The references to SOI structures herein are made to facilitate the explanation of the embodiments described herein and are not intended to, and should not be interpreted as, limiting the claims in any way. The SOI abbreviation is used herein to refer to semiconductor-on-insulator structures in general, including, but not limited to, semiconductor-on-glass (SOG) structures, silicon-on-insulator (SOI) structures, and silicon-on-glass (SiOG) structures, which also encompasses silicon-on-glass-ceramic structures. Various embodiments disclosed herein also have application to semiconductor-on-semiconductor SOI applications assuming that acoustic energy is produced during the fabrication process.

With reference to FIG. 2, a donor semiconductor wafer 120 may be used in the production of, or development of, an SOI device. In the context of the embodiments discussed herein, the donor semiconductor wafer 120 and substrate 102 (e.g., a glass or glass-ceramic material) may be the sample structure from which certain bonding characteristics are sought. Again, however, the sample material being semiconductor and the substrate being glass or glass ceramic are only for example, and the apparatus 100 and/or other methods and apparatus described herein may operate on semiconductor-on-semiconductor SOI and other materials.

A donor semiconductor wafer 120 may have been prepared, such as by polishing, cleaning, etc. to produce a relatively flat and uniform implantation surface 121 suitable for bonding to the glass or glass-ceramic substrate 102. For the purposes of discussion, the semiconductor wafer 120 may be a substantially single crystal Si wafer, although any other suitable semiconductor conductor material may be employed, such as the III-V, II-IV, II-IV-V, etc. classes of semiconductors. Examples of these materials include: silicon (Si), germanium-doped silicon (SiGe), silicon carbide (SiC), germanium (Ge), gallium arsenide (GaAs), gallium nitride (GaN), gallium phosphide (GaP), and indium phosphide (InP).

An exfoliation layer 122 is created by subjecting the implantation surface 121 to one or more ion implantation processes to create a weakened region 123 below the implantation surface 121 of the donor semiconductor wafer 120. Although the embodiments herein are not limited to any particular method of forming the exfoliation layer 122, one suitable method dictates that the implantation surface 121 of the donor semiconductor wafer 120 may be subject to a hydrogen ion implantation process to at least initiate the creation of the exfoliation layer 122 in the donor semiconductor wafer 120. The implantation energy may be adjusted using conventional techniques to achieve a general thickness of the exfoliation layer 122, such as between about 300-500 nm, although any reasonable thickness is within the scope of the embodiments herein. By way of example, hydrogen ion implantation may be employed, although other ions or multiples thereof may be employed, such as boron+hydrogen, helium+hydrogen, or other ions known in the literature for exfoliation. Again, any other known or hereinafter developed technique suitable for forming the exfoliation layer 122 may be employed.

Regardless of the nature of the implanted ion species, the effect of implantation on the exfoliation layer 122 is the displacement of atoms in the crystal lattice from their regular locations. When the atom in the lattice is hit by an ion, the atom is forced out of position and a primary defect, a vacancy and an interstitial atom, is created, which is called a Frenkel's pair. If the implantation is performed near room temperature, the components of the primary defect move and create many types of secondary defects, such as vacancy clusters, etc. Most of these types of defects are electrically active, and serve as traps for major carriers in the semiconductor lattice.

The resultant structure of the donor semiconductor wafer 120 is thus a material layer (the exfoliation layer 122) extending from the implantation surface 121 to a depth within the material and a layer of weakness 123 below the material layer. The implantation dose used in the formation of the layer of weakness 123 may be relatively high, much higher than doses used in later doping techniques. Thus, the layer of weakness 123 may be described as a mix of semiconductor (e.g., silicon) and hydrogen. Also, the layer of weakness 123 includes several types of defects that are unique to, for example, situations where heavy dose implantation of hydrogen into silicon has been carried out. For example, the defects may include hydrogen filled bubbles, hydrogen platelets, and hydrogenated vacancy clusters.

With the above background concerning the structure of an exemplary material 120 (such as the aforementioned donor semiconductor wafer), the apparatus 100 operates to provide in-situ monitoring of the bonding process by detecting acoustic emission signals originating, for example, from a rapid redistribution of stresses in the semiconductor wafer 120 during exfoliation. Acoustic energy emanating from, or proximate to, the interface of the semiconductor material 120 and the substrate 102 is picked up by the sensor(s) 108, converted into electronic acoustic signals, and delivered to the signal conditioning circuitry 104 over conductor 110. The computing system 106 includes a processor capable of running computer executable code, which is set up to compute the one or more characteristics of the bond in response to various parameters of the acoustic signals. Analysis of the measured acoustic energy signals may include the determination and analysis of signal amplitude, frequency, reference crossing counts, rise time, and/or energy, etc. The acoustic energy may be produced by formation of one or more defects in the semiconductor wafer 120 or in the bonding interface between the wafer 120 and the substrate 102 during the bonding process. Thus, the dynamics of the bonding process, including formation of defects, micro cracking, and exfoliation, can be non-destructively monitored. The computed characteristics may be provided to a user of the apparatus 100 by way of a display means within the computing system 106, such as a computer screen, a print-out, etc.

Although any suitable type of acoustic sensor 108 may be employed, it is anticipated that a piezoelectric transducer may be particularly suited to measure the acoustic energy in the substrate 102, at least in part due to a balance between performance versus cost.

In one or more alternative embodiments, the acoustic sensors may be implemented using one or more remote, non-contact or airborne acoustic sensors 108′ (FIG. 1). The acoustic sensors need not be coupled to the substrate 102, the material 120, or intermediate structures, in order to sense the acoustic energy within the substrate 102. Indeed, a non-contact acoustic sensor 108′ is operable to sense acoustic energy in a body (e.g., the substrate 102) from a distance, without contacting the substrate. Such a configuration may be advantageous in high temperature applications because the air gap (distance) between the substrate 102 (or other structure) and the non-contact acoustic sensor 108′ may provide a barrier that significantly reduces the complexities and precautions necessary to protect the sensors from high temperatures. The separation between the non-contact acoustic sensors 108′ and the substrate 102 may also be advantageous in production environments because the process of coupling sensors to the substrate 102 may be eliminated. Rather, the non-contact acoustic sensors 108′ may be fixed in position and the substrate 102 (or other portion of the SOI structure) may be brought into registration therewith, or vice verse. In some embodiments, the positioning of the SOI structure and the non-contact acoustic sensors 108′ may be automated using any of the known conveyance technologies. The non-contact acoustic sensors 108′ may be located about the substrate 102 at positions that yield appropriate electrical signals in response to acoustic energy 112 to achieve the objectives discussed herein. By way of example, suitable non-contact acoustic sensors may be obtained from any number of vendors, such as Physical Acoustics Corporation, Princeton Junction, N.J.

Assuming that the material 120 is a silicon wafer and the substrate 102 is a glass or glass-ceramic material, then the amplitude and frequencies of the acoustic signal of interest may be around 1-10 arbitrary units at greater than 20 KHz (such as between about 100 KHz and 2 MHz). The signal conditioning circuitry 104, therefore, may operate to process a raw signal coming from an non-contact acoustic sensor 108, and/or a piezoelectric type of acoustic sensor 108 (such as by filtering, amplifying, etc.) prior to input to the computing system 106.

The signal conditioning circuitry 104 and the computing system 106 may be separately implemented as illustrated in FIG. 1 or they may be integrated depending on the exigencies of the application. The hardware of the signal conditioning circuitry 104 and/or the computing system 106 may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc.

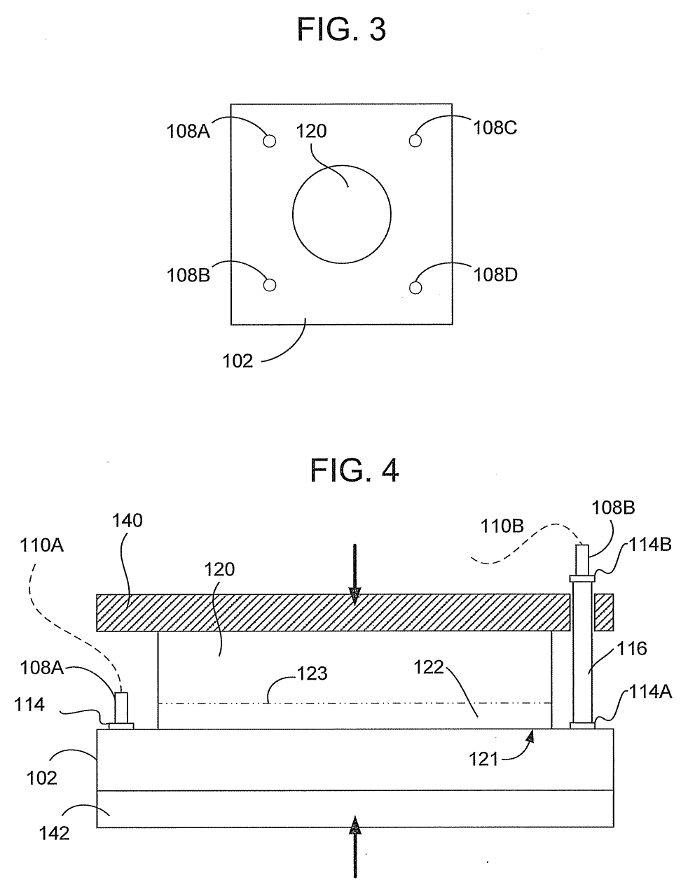

With reference to FIGS. 3-4, the apparatus 100 may include a plurality of acoustic sensors 108A, 108B, 108C, 108D, each producing acoustic signals in response to a given acoustic event during the bonding process. While four sensors 108 are shown in FIG. 3, any number may be employed depending on the particular application.

FIG. 4, a side view of an anodic bonding apparatus, shows that two acoustic sensors 108A, 108B may be employed, each with a respective conductor 110A, 110B. In the anodic bonding process, an upper and lower plate 140, 142 may provide pressure, temperature and voltage to the semiconductor wafer 120 and the glass or glass ceramic substrate 102 to facilitate anodic bonding therebetween. Separation (exfoliation) of the layer 122 from the semiconductor wafer 120 may take place during cooling, heating, dwell, etc. A given acoustic sensor, such as sensor 108A, may be coupled to the surface of the substrate 102 as shown (or may be coupled to some other suitable structure, such as the wafer 120) by way of a sensor coupling 114 (which may include an appropriate adhesive). As the temperature of the bonding process may be significant, it may be desirable to employ a high temperature acoustic sensor 108A. Lower temperature acoustic sensors may also be employed in the, aforementioned anodic bonding process, however, additional structure may be required to prevent excessive temperatures at the acoustic sensor 108 itself. For example, one approach employs a waveguide 116 between the sensor coupling 114A and the lower temperature acoustic sensor 108B. An additional coupling 114B (preferably including a high viscosity liquid) is employed between the waveguide 116 and the senor 108B to ensure that acoustic energy is coupled up to the sensor from the surface of the substrate 102. Another alternative would be application of non-contact or remote sensors, in which the sensors couple to the substrate via an acoustic signal traveling through air.

The signal conditioning circuitry 104 and the computing system 106 may include specific signal conditioning and analysis features to account for particularities of the acoustic signals produced in the context of anodic bonding, exfoliation, and/or material cracking or void formation. For example, the computing system 106 may operate to analyze at least one of amplitude, frequency, reference crossings, rise time, fall time, energy, and velocity characteristics of the acoustic signals to derive the at least one characteristic of the anodic bonding process.

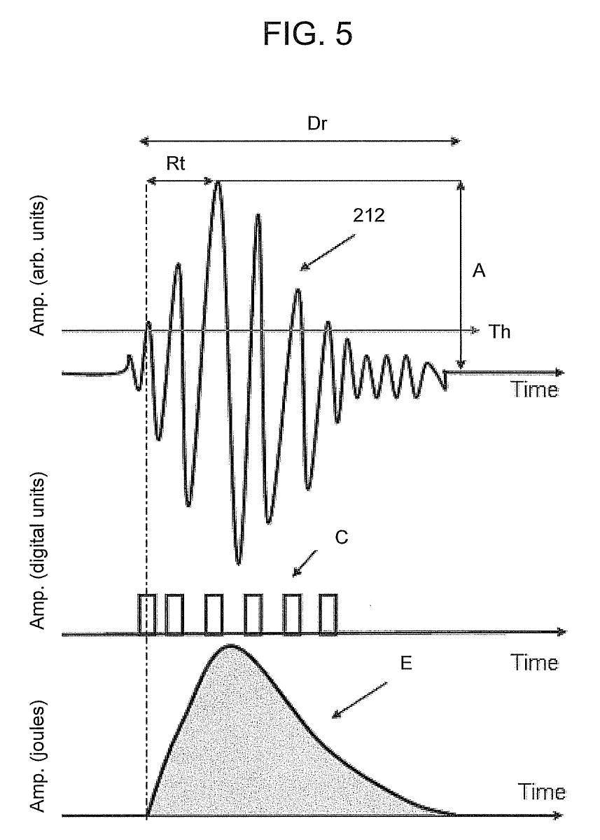

Reference is now made to FIG. 5, which is a graphical illustration of an electronic acoustic signal 212 produced by an acoustic sensor 108 in response to measured acoustic energy using the apparatus of FIG. 1. In each graph, amplitude is depicted on the Y-axis (in arbitrary units for the upper graph, digital units for the middle graph and joules for the lower graph) and time is depicted on the X-axis (typically in microseconds). The signal 212 has a characteristic burst envelope, which, for example, includes a rise time, Rt, measured from signal initiation to a maximum positive (or negative) amplitude, A. The signal 212 exhibits a characteristic (or fundamental) frequency for a duration, Dr, and rings down from the maximum amplitude, A to about zero. In order to accurately analyze the above characteristics of the signal 212, it may be necessary for the signal conditioning circuitry 104 to filter the raw signal from the acoustic sensor 108 (such as by way of high pass filtering, or band-pass filtering) to obtain the signal 212 of interest. Again, the frequencies of interest in the signal 212 are likely to be between about 100 KHz to about 2 MHz. As an energy level of the signal 212 may be of interest in determining the one or more characteristics of the bonding process, the computing system 106 may include specific analysis features to compute the area under the curve of the signal 212, which may include an integration function. The energy of the signal 212 is graphically illustrated as the curve, E, at the bottom of FIG. 5.

When compared to a threshold level, Th, reference crossings (or counts), C, may be obtained. For example, the signal conditioning circuitry 104 and/or the computing system 106 may include a comparator circuit, which operates to output a logic true (or digital 1) when the signal amplitude is above the threshold Th. Alternative comparator circuit designs may operate to output a logic true (or digital 1) when the signal amplitude is below the threshold Th. In any event, the reference crossings signal C may be useful in determining duration, frequency, etc.

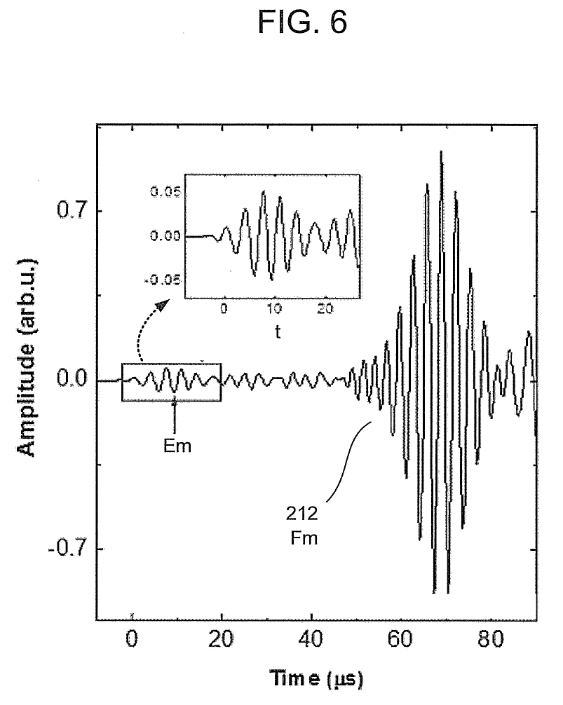

With reference to FIG. 6, the comparison of the signal 212 to another type of threshold may also be advantageous. FIG. 6 is a graphical illustration of a measured acoustic emission signal having two wave modes obtained from a glass substrate. Signal amplitude is along the Y-axis (measured in arbitrary units) and time is along the X-axis (measured in micro-seconds). Acoustic energy within the substrate 102 may include multiple wave modes (Lamb waves). For example, in a thin glass plate of thickness 0.5 nm, two strong modes (extensional and flexural) are detectable while the amplitude and the propagation velocities of the respective acoustic energy waves are significantly different. The flexural mode (Fm) of signal 212 has lower velocity while carrying most of the energy (high amplitude). In contrast, the extensional mode (Em) has a higher propagation velocity within the substrate 102 while carrying lower energy (low amplitude). The selection of the wave mode of interest in analysis of the acoustic signal 212 is important. Such selection may be achieved by establishing a predetermined threshold below which signal amplitudes are ignored. For example, the flexural mode signal (Fm) may be captured by selecting a threshold value greater than the amplitude of the extensional mode signal (Em).

When the apparatus 100 includes at least three acoustic sensors 108, each producing acoustic signals in response to a given acoustic event, then the specific location of the acoustic event may be determined. The computing system 106 may include appropriate algorithms (available in the art) to execute a triangulation process on the acoustic signals 212 in order to compute one or more specific locations from which the acoustic energy originates.

A source location map of the acoustic energy (which usually originates from rapid redistribution of stresses in the semiconductor wafer 120) may be obtained from the aforementioned triangulation. For the case of a two dimensional location map, at least three sensors 108 are required for source location detection. Better location accuracy may be achieved by adding additional sensors 108 to the system. The accuracy of the acoustic energy location analysis is affected by the mixing of different wave modes, signal attenuation, dispersion, and reflections. In addition, the wavelength of the acoustic signal is also a factor in the accuracy of source location through triangulation. This is so because all the aforementioned phenomena affect the accurate determination of the arrival time of the wave and the measurement of the same mode by all the sensors. Therefore, selection of the threshold (discussed above with respect to FIG. 6) and the suppression of reflections is very important for high location accuracy.

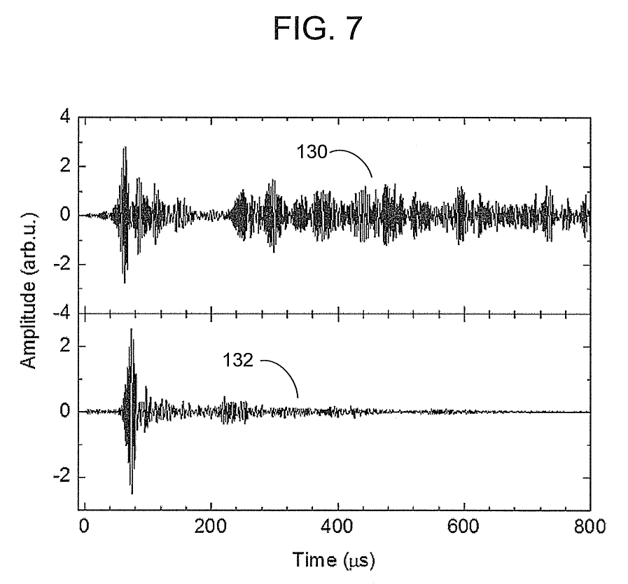

The accuracy of the computed location of origination of a given event giving rise to acoustic energy may be improved when the reflections within the substrate 102 are reduced or minimized. FIG. 7 includes a graphical illustration of two acoustic signals, 130, 132, each measured by an acoustic sensor 108 during experimentation. In the illustrated graph, the signal amplitude is along the Y-axis (in arbitrary units), and time is along the X-axis (in micro-seconds). When signal reflections within the substrate 102 are pervasive and significant, then the acoustic signals generated by a given acoustic sensor 108 may include the characteristics shown in graph 130. Graph 130 includes a signal burst (at the far left) associated with an acoustic event giving rise to acoustic energy, followed by numerous secondary bursts resulting from the initial burst bouncing off of discontinuities of the substrate 102 (particularly the surface edges thereof). The secondary bursts, however, do not contain any useful information regarding the bonding characteristics of interest, and are likely to interfere with the measurement of useful information.

When signal reflections within the substrate 102 are not pervasive or significant, then the acoustic signals generated by a given acoustic sensor 108 may include the characteristics shown in graph 132. Graph 132 includes a signal burst (at the far left) associated with an acoustic event giving rise to acoustic energy, followed by few or no further secondary bursts. Reduction and/or minimization of signal reflections within the substrate may be obtained by applying an anti-reflection coating at the surrounding edges of the substrate 102 to modify the surfaces thereof. The coating may need to be relatively thick, similar to known optical AR coatings. By way of example, the anti-reflection coating material may be formed from silicone or cement, such as high temperature silicone or high temperature cement for high temperature applications. For relatively low temperature applications, hot glue or bee's wax may be employed (if the substrate edges overhang the upper and/or lower plates 140, 142). The coating may be applied to the substrate edges at a thickness of about 1.0-0.5 mm, without leaving any air gap therebetween.

The computing system 106 may also include appropriate algorithms (available in the art) to determine velocities of the acoustic signals. For example, the acoustic wave velocity in the substrate 102 may be calculated by measuring a time difference of an acoustic wave traveling between two sensors 108. While the specific formula for computing the acoustic wave velocity in the substrate 102 may depend on various physical parameters, when the acoustic signal origin is generally on a line defined by two sensors 108, the velocity of the acoustic wave may be expressed by following equation:

v=Δx/(t2−t1),

where v=the velocity of the acoustic wave in a thin sheet of glass; t2−t1 a computed time difference of two acoustic waves traveling from a given position (e.g., a position of origin) to two different sensors 108; and Δx is a distance between the two sensors 108.

The apparatus 100 may also include further data measurement devices (not shown) that operate to collect further information during the bonding process. For example, the apparatus 100 may include at least one of a temperature sensor, a pressure sensor, and a voltage sensor, operating to produce at least one of a temperature signal, a pressure signal, and a voltage signal, respectively, associated with parameters of the bonding process. The signal conditioning circuitry 104 and/or the computing system 106 may separately or collectively operate to associate the measured acoustic signals 212 with at least one of the temperature signal, the pressure signal, and the voltage signal in order to provide additional information and analysis opportunities concerning the bonding process. For example, the signal conditioning circuitry 104 and/or the computing system 106 may operate to associate a formation of one or more defects (e.g., in the semiconductor wafer 120) with at least one of the temperature signal, the pressure signal, and the voltage signal.

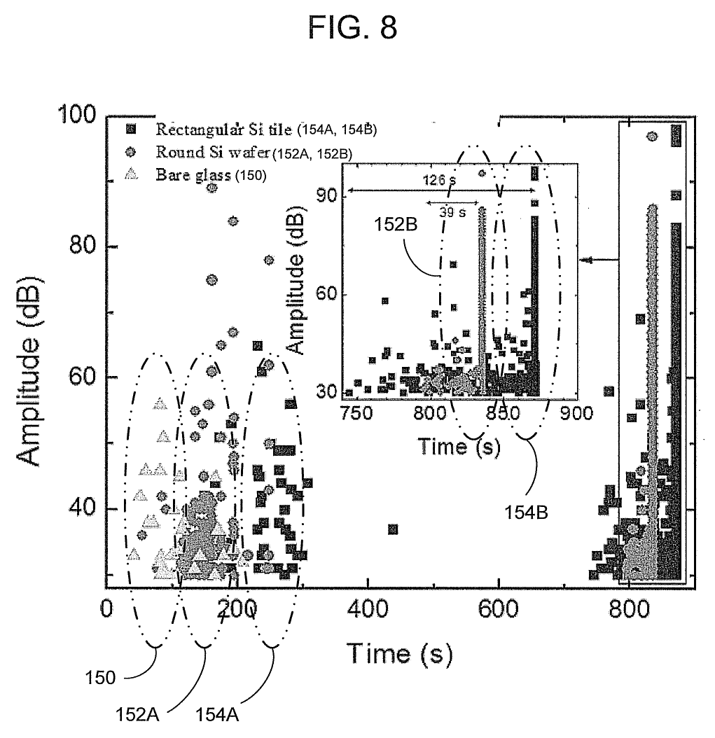

Experimental data has been obtained by coupling a number of sensors 108 to a glass substrate 102 and monitoring acoustic energy within the substrate 102 resulting from exfoliation events occurring during an anodic bonding process using an apparatus very similar to that of FIGS. 1-4. FIG. 8 is a graphical illustration of three measured acoustic signals 150, 152 (comprised of signal portions 152A and 152B, shown as a series of circles), and 154 (comprised of signal portions 154A and 154B, shown as a series of squares) during the experiment. The portion of the graph containing signal portions 152B and 154B has been expanded in time to reveal additional signal characteristics. The signal 150 (shown as a series of triangles) was obtained from a reference, glass substrate-only sample. The next signal 152 was obtained from a sample having a round semiconductor material 120 bonded to the substrate 102. The final signal 154 was obtained from a sample having a rectangular (tiled) semiconductor material 120 bonded to the substrate 102. The graph shows the amplitude (in dB) of the measured acoustic signals 150, 152, 154 as a function of time (in seconds).

Common to all investigated exfoliation experiments that were conducted, acoustic activities during the exfoliation events may be divided into two time zones: time zone 1, between about 0 and 500 s, and time zone 2, greater than about 700 s. Signal 150, and signals portions 152A and 154A fall within time zone 1, and signal portions 152B and 154B fall within time zone 2. Between time zone 1 and time zone 2 is a region without any acoustic energy activity. It is noted that the above-mentioned time zones may change, in terms of location and duration, based upon the experimental conditions, for example, voltage, pressure, heating rate, etc.

The acoustic energy characteristics for the exfoliation activity of the samples having the rectangular semiconductor material (signal portions 152A and 152B) and the round semiconductor material (signal portions 154A and 154B) were significantly different from the acoustic activity associated with the bare glass substrate heating (signal 150).

In time zone 1, the acoustic energy amplitude (and thus the intensity of exfoliation activity) of signals 152 and 154 are stronger than for the bare glass substrate 102, signal 150. The heating of the bare glass substrate (signal 150) shows only weak acoustic emission for about 200 seconds within time zone 1, and there is essentially no portion of signal 150 that falls within time zone 2. In contrast, the variation of the acoustic energy amplitude associated with the exfoliation events of signals 152 and 154 last over 800 seconds and the amplitude is much stronger as compared with the signal 150. This indicates that the strong characteristic acoustic signal generated in time zone 2 is only due to exfoliation related phenomena.

The acoustic energy signals in time zone 1 are not only due to background noise, for example due to the heating of the glass substrate 102, but also due to exfoliation activity or other bonding activity. Although a significant portion of the acoustic energy during time zone 1 may originate from exfoliation activities, the separation and identification of the acoustic energy associated with exfoliation and compared with bare glass heating activities are not trivial exercises. In any case, the acoustic energy within time zone 1 does not appear to be directly related to the main exfoliation events of interest, which clearly occur during time zone 2.

The acoustic energy signal portions 152B and 154B in time zone 2 initiate at about 740 seconds and then progresses until they reach highest amplitudes of about 100 dB after more than about 800 seconds. This progression is an indication of pre-cracking prior to the exfoliation layer 122 cleaving (or splitting from) the semiconductor wafer 120. The highest acoustic energy signal was observed at approximately the same time as an audible “pop” sound and associated visual observation of the exfoliation event. The time difference between the start of pre-cracking and the highest acoustic energy peak was about 126 seconds for the rectangular silicon wafer 120 and about 39 seconds for the round silicon wafer 120. It is noted that the above time differences may vary significantly with experimental conditions, for example implantation dose, heating rate, etc. Thus, based on the evidence available at present, it is not clear that there is any fundamental difference between round and rectangular silicon wafers 120.

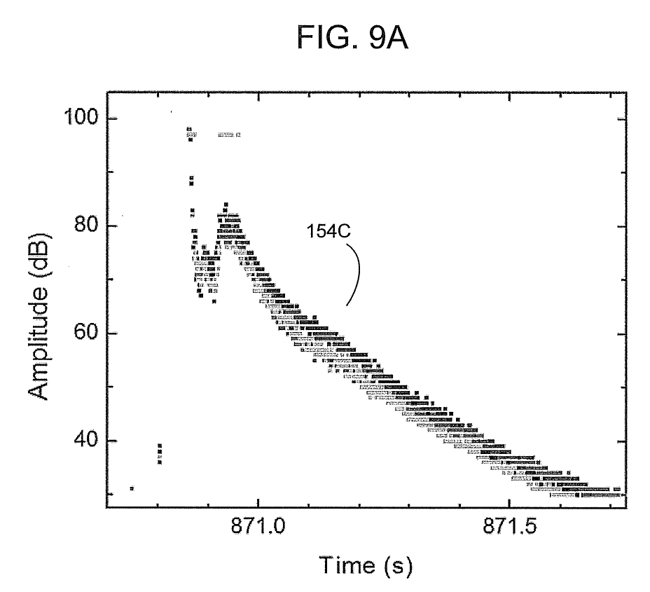

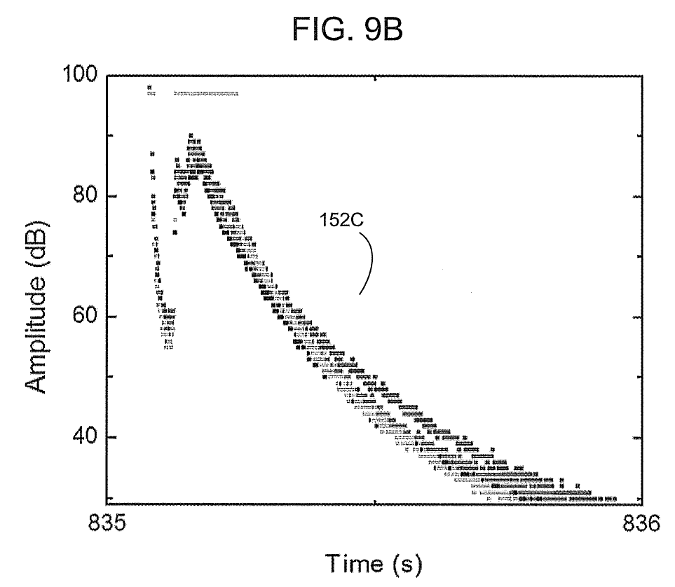

With reference to FIGS. 9A and 9B, additional experimental data were gathered. FIGS. 9A and 9B are graphical illustrations of the respective amplitudes (in dB) of further signal portions of the measured acoustic emission events. The FIG. 9A signal 154C was obtained from the sample having the rectangular semiconductor material bonded to the substrate, and the FIG. 9B signal 152C was obtained from the sample having the round semiconductor material bonded to the substrate. The signals 152C and 154C were recorded around the time of the exfoliation event. The results show that both the rectangular and round semiconductor materials share very similar acoustic characteristics near the splitting event. For both cases, the acoustic amplitude includes three distinct emission peaks separated by less than about a second. It appears likely that the strongest acoustic energy signal is associated with the splitting of the semiconductor wafer from the exfoliated layer 122 remaining bonded to the glass.

Variations of the acoustic energy amplitude and the emission rate around the time of exfoliation (e.g., in time zone 2) therefore revealed detailed information about the exfoliation process. The acoustic energy generated during time zone 2 may be interpreted as a release of transient waves produced by rapid redistribution of stress in the semiconductor material (and/or the glass substrate) due to the exfoliation process. Such acoustic activity may take place before, during, and sometimes just after the exfoliation. As indicated above with respect to FIG. 8, the acoustic energy graphs clearly show pre-cracking events, possibly related to the formation of blisters or platelets during the process, or to the formation of voids in the semiconductor exfoliation layer 122.

Observations were made of a semiconductor-on-glass structure just after exfoliation, which included several large voids. An acoustic energy source location map was produced using the aforementioned triangulation technique (where signals were obtained from four sensors). A comparison of the acoustic energy source location map with the actual location of the voids on the semiconductor-on-glass structure revealed a clear correlation. The above measurements and analysis indicates that the formation of voids was captured by the acoustic energy location map, which establishes the viability of the acoustic energy measuring and analysis techniques disclosed herein, and the capability of detecting the formation of defects during the bonding process.

Although the embodiments herein have been described with reference to particular features, it is to be understood that these embodiments are merely illustrative of the principles and applications thereof. It is therefore to be understood that numerous modifications may be made to the illustrative embodiments and that other arrangements may be devised without departing from the scope of the appended claims.

1. An apparatus for in-situ measurement of at least one characteristic of a bonding process between a material sheet and a substrate, comprising:
at least one acoustic sensor operating to produce acoustic signals in response to acoustic energy produced proximate to a bonding interface between the material sheet and the substrate; and
a processing circuit operating to analyze the acoustic signals and derive the at least one characteristic of the bonding process therefrom.

2. The apparatus of claim 1, wherein the acoustic energy is produced by an exfoliation of a layer from the material sheet that is being bonded to the substrate.

3. The apparatus of claim 1, wherein at least one of:
the acoustic energy is produced by formation of one or more defects in the material sheet or in the bonding interface between the material sheet and the substrate during the bonding process; and
the formation of one or more defects includes one or more of voids and cracks.

4. The apparatus of claim 1, further comprising at least one of a temperature sensor, a pressure sensor, and a voltage sensor, operating to produce at least one of a temperature signal, a pressure signal, and a voltage signal, respectively, associated with parameters of the bonding process,
wherein the processing circuit further operates to associate the acoustic signals with at least one of the temperature signal, the pressure signal, and the voltage signal.

5. The apparatus of claim 4, wherein at least one of:
the processing circuit further operates to associate a formation of one or more defects in the material sheet or in the bonding interface between the material sheet and the substrate during the bonding process with at least one of the temperature signal, the pressure signal, and the voltage signal; and
the processing circuit further operates to identify respective states of one or more of the temperature signal, the pressure signal, and the voltage signal at initiation of the formation of the one or more defects.

6. The apparatus of claim 1, wherein:
the at least one acoustic sensor includes at least three acoustic sensors, each producing acoustic signals; and
the processing circuit further operates to compute one or more locations from which the acoustic energy originates proximate to the bonding interface.

7. The apparatus of claim 6, wherein the acoustic energy is produced by formation of one or more defects in the material sheet or in the bonding interface between the material sheet and the substrate during the bonding process.

8. The apparatus of claim 1, wherein the processing circuit further operates to filter frequencies of the acoustic signals to fall within a range of about 100 KHz to about 2 MHz.

9. The apparatus of claim 1, wherein the processing circuit further operates to ignore portions of the acoustic signals having amplitudes below a predetermined threshold.

10. The apparatus of claim 1, wherein the processing circuit further operates to analyze at least one of amplitude, frequency, reference crossings, rise time, fall time, energy, and velocity characteristics of the acoustic signals to derive the at least one characteristic of the bonding process therefrom.

11. The apparatus of claim 1, further comprising one or more modified surfaces on the substrate for reducing internal reflections of the acoustic energy within the substrate.

12. The apparatus of claim 1, wherein the least one acoustic sensor is coupled to at least one of the material sheet and the substrate.

13. The apparatus of claim 1, wherein the least one acoustic sensor is one or more non-contact acoustic sensors operating to produce the acoustic signals without contacting the material sheet or the substrate.

14. The apparatus of claim 1, further comprising at least one waveguide disposed between the at least one acoustic sensor and the substrate.

15. A method of measuring, in-situ, at least one characteristic of a bonding process between a material sheet and a substrate, comprising:
producing acoustic signals in response to acoustic energy within at least one of the material sheet and the substrate proximate to a bonding interface between the material sheet and the substrate; and
deriving the at least one characteristic of the bonding process from the acoustic signals.

16. The method of claim 15, wherein the acoustic energy is produced by at least one of:
an exfoliation of a layer from the material sheet that is being bonded to the substrate;
formation of one or more defects in the material sheet or in the bonding interface between the material sheet and the substrate during the bonding process.

17. The method of claim 15, further comprising at least one of:
sensing at least one of temperature, pressure, and voltage associated with parameters of the bonding process;
associating the acoustic signals with at least one of the temperature, the pressure, and the voltage;
associating a formation of one or more defects in the material sheet or in the bonding interface between the material sheet and the substrate during the bonding process with at least one of the temperature, the pressure, and the voltage; and
identifying respective states of one or more of the temperature, the pressure, and the voltage at initiation of the formation of the one or more defects.

18. The method of claim 15, further comprising:
producing at least three sources of acoustic signals for a given source of acoustic energy; and
computing one or more locations from which the acoustic energy originates proximate to the bonding interface from the at least three sources of acoustic signals.

19. The method of claim 18, wherein the acoustic energy is produced by formation of one or more defects in the material sheet or in the bonding interface between the material sheet and the substrate during the bonding process.

20. The method of claim 15, further comprising at least one of:
filtering frequencies of the acoustic signals to fall within a range of about 100 KHz to about 2 MHz;
ignoring portions of the acoustic signals having amplitudes below a predetermined threshold; and
analyzing at least one of amplitude, frequency, reference crossings, rise time, fall time, energy, and velocity characteristics of the acoustic signals to derive the at least one characteristic of the bonding process therefrom.
